(19) United States
(12) Patent Application Publication
(10) Pub. No.: US 2024/0319952 A1
(43) Pub. Date: Sep. 26, 2024

(54) DISPLAY SYSTEM, DISPLAY METHOD, AND NON-TRANSITORY RECORDING MEDIUM

(71) Applicants: Ayano Inoue, Kanagawa (JP); Susumu Fujioka, Kanagawa (JP)

(72) Inventors: Ayano Inoue, Kanagawa (JP); Susumu Fujioka, Kanagawa (JP)

(73) Assignee: Ricoh Company, Ltd., Tokyo (JP)

(21) Appl. No.: 18/431,122

(22) Filed: Feb. 2, 2024

(30) Foreign Application Priority Data
Mar. 22, 2023 (JP) 2023-045320

(51) Int. Cl. G06F 3/14; G06F 3/044; G06F 3/147

(52) U.S. Cl. CPC G06F 3/1454; G06F 3/044; G06F 3/147

(57) ABSTRACT

A display system includes a display with a touch panel and an information processing apparatus including circuitry to detect connection with the display, determine whether an application executed by the circuitry of the information processing apparatus is a specific application registered in advance, transmit, based on a determination that the application is the specific application, screen data of the specific application to the display whose connection is detected, and receive coordinate data indicating an operation position on a screen displayed by the display based on the screen data. In the display system, the specific application executes a process according to the coordinate data.

### CROSS-REFERENCE TO RELATED APPLICATIONS

This patent application is based on and claims priority pursuant to 35 U.S.C. § 119(a) to Japanese Patent Application No. 2023-045320, filed on Mar. 22, 2023, in the Japan Patent Office, the entire disclosure of which is hereby incorporated by reference herein.

### BACKGROUND

### Technical Field

Embodiments of the present disclosure relate to a display system, a display method, and a non-transitory recording medium.

### Related Art

While a conference is being held using a communication terminal such as a personal computer (PC) without a touch panel, an application that allows the PC to share a virtual whiteboard (referred to as a “whiteboard application” in the following description) is used in some cases. In such cases, an operator draws on the whiteboard using a mouse. However, it is difficult for the operator to draw using the mouse.

A technique is disclosed, in which a touch panel display, in cooperation with a mobile terminal, assists input to the mobile terminal.

### SUMMARY

In one aspect, a display system includes a display with a touch panel and an information processing apparatus including circuitry to detect connection with the display, determine whether an application executed by the circuitry of the information processing apparatus is a specific application registered in advance, transmit, based on a determination that the application is the specific application, screen data of the specific application to the display whose connection is detected, and receive coordinate data indicating an operation position on a screen displayed by the display based on the screen data. In the display system, the specific application executes a process according to the coordinate data.

In another aspect, a display method includes detecting connection with a display with a touch panel, determining whether an application executed by an information processing apparatus is a specific application registered in advance, transmitting, based on a determination that the application is the specific application, screen data of the specific application to the display whose connection is detected, receiving coordinate data indicating an operation position on a screen displayed by the display based on the screen data, and with the specific application, executing a process according to the coordinate data.

In another aspect, a non-transitory recording medium storing a plurality of program codes which, when executed by one or more processors, causes the one or more processors to perform a method including detecting connection with a display with a touch panel, determining whether an application executed by an information processing apparatus is a specific application registered in advance, transmitting, based on a determination that the application is the specific application, screen data of the specific application to the display whose connection is detected, receiving coordinate data indicating an operation position on a screen displayed by the display based on the screen data, and with the specific application, executing a process according to the coordinate data.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating a configuration of a system according to the first embodiment of the present disclosure;

FIG. 2 is a block diagram illustrating a functional configuration of a conference server according to the first embodiment of the present disclosure;

FIG. 3 is a block diagram illustrating a hardware configuration of a laptop personal computer (PC) according to the first embodiment of the present disclosure;

FIG. 4 is a block diagram illustrating a functional configuration of a laptop personal computer (PC) according to the first embodiment of the present disclosure;

FIG. 5 is an external view of a touch panel display according to the first embodiment of the present disclosure;

FIG. 6 is a block diagram illustrating a hardware configuration of a touch panel display according to the first embodiment of the present disclosure;

FIG. 7 is a block diagram illustrating a functional configuration of a touch panel display according to the first embodiment of the present disclosure;

FIG. 8 is a diagram illustrating virtual overlap of display data in a display memory area according to an embodiment of the present disclosure;

FIG. 9 is a sequence chart illustrating the processing executed by a system according to the first embodiment of the present disclosure;

FIG. 10 is a diagram illustrating a configuration of a system according to the second embodiment of the present disclosure;

FIG. 11 is a sequence chart illustrating the processing executed by a system according to the second embodiment of the present disclosure;

FIG. 12 is a sequence chart illustrating the processing executed by a system according to the third embodiment of the present disclosure;

FIG. 13 is a sequence chart illustrating the processing executed by a system according to the fourth embodiment of the present disclosure;

FIG. 14 is a block diagram illustrating a functional configuration of a laptop personal computer (PC) according to the fifth embodiment of the present disclosure;

FIG. 15 is a block diagram illustrating a functional configuration of a touch panel display according to the fifth embodiment of the present disclosure; and

FIG. 16 is a sequence chart illustrating a procedure in which a laptop personal computer (PC) connects to a touch panel display by wireless communication, according to the fifth embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

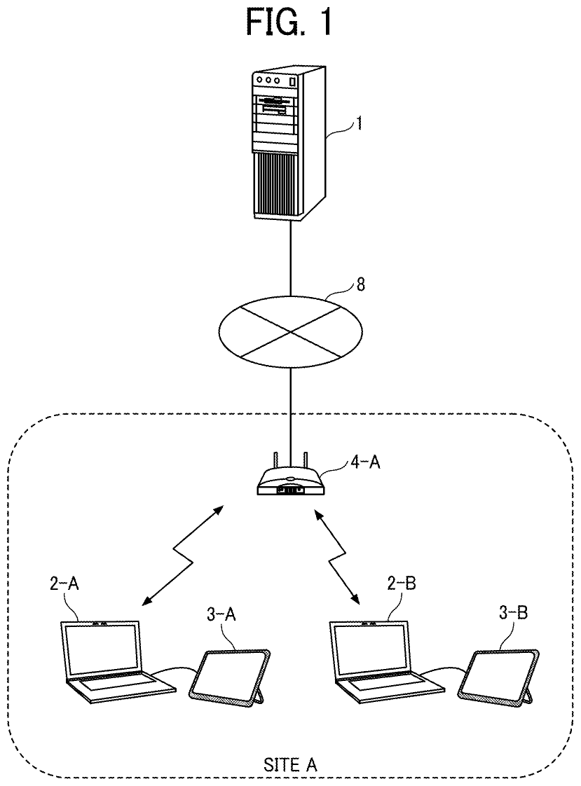

Embodiments of the present disclosure are described below with reference to the drawings. FIG. 1 is a diagram illustrating a configuration of a system according to the first embodiment of the present disclosure.

In FIG. 1, a site A is a conference room in a company (referred to as a “company X” in the following description). In the site A, for example, a wireless local area network (LAN) access point 4-A, a laptop personal computer (PC) 2-A and a touch panel display 3-A, and a laptop PC 2-B and a touch panel display 3-B are provided. The wireless LAN access point 4-A is connected to a conference server 1 via a network 8. The laptop PCs 2-A and 2-B are connected to the conference server 1 via the wireless LAN access point 4-A. The laptop PCs 2-A and 2-B are referred to as “laptop PCs 2 when the laptop PCs 2-A and 2-B are referred to without distinction or collectively, and one thereof is referred to as a “laptop PC 2.” Similarly, the touch panel displays 3-A and 3-B are referred to as “touch panel displays 3 when the touch panel displays 3-A and 3-B are referred to without distinction or collectively, and one thereof is referred to as a “touch panel display 3.” The touch panel displays 3-A and 3-B are connected to the laptop PCs 2-A and 2-B via universal serial bus (USB) cables, respectively.

The laptop PCs 2 and the touch panel displays 3 form a display system used by participants in a face-to-face conference (referred to simply as a “conference” in the following description) in the site A.

The laptop PC 2 is an information processing apparatus that activates various applications used in a conference in response to an operation performed by an operator. In the present embodiment, a whiteboard application is installed in the laptop PC 2. The whiteboard application is an application that allows a plurality of communication terminals (such as the laptop PCs 2) to share a virtual whiteboard on which, for example, handwritten information can be written, via the conference server 1.

The touch panel display 3 is given by way of example as a display with a touch panel. The touch panel display 3 is used for displaying and operating a screen of a specific application among the applications activated on the laptop PC 2. In the present embodiment, the whiteboard application serves as a specific application.

The conference server 1 is a computer that executes the control of the conference. For example, a computer conforming to the personal computer AT (PC/AT) architecture may be used as the conference server 1.

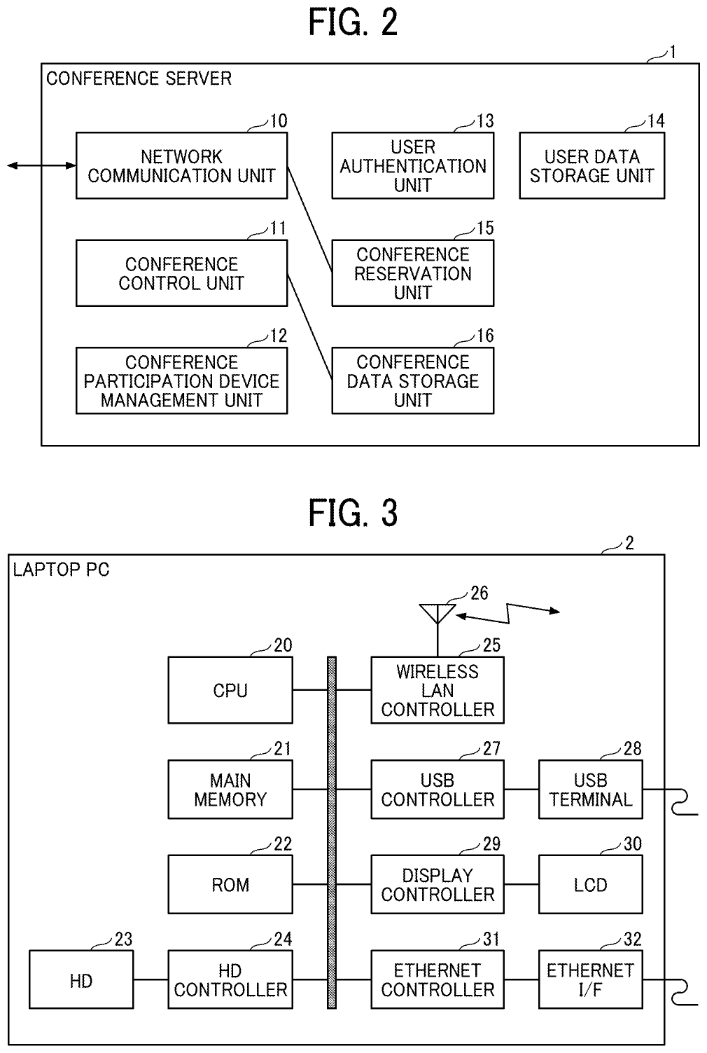

FIG. 2 is a block diagram illustrating a functional configuration of the conference server 1 according to the first embodiment of the present disclosure. As illustrated in FIG. 2, the conference server 1 includes, for example, a network communication unit 10, a conference control unit 11, a conference participation device management unit 12, a user authentication unit 13, and a conference reservation unit 15. These functional units provide functions implemented by a central processing unit (CPU) of the conference server 1 executing instructions included in one or more programs installed in the conference server 1. The conference server 1 also includes a user data storage unit 14 and a conference data storage unit 16. Each of these storage units is implemented by using, for example, an auxiliary storage device of the conference server 1 or a storage device connectable to the conference server 1 via a network.

The network communication unit 10 transmits and receives data to and from each laptop PC 2 using Web Real-Time Communication (WebRTC). The network communication unit 10 also transmits and receives data for authenticating the operator of each laptop PC 2 using Hypertext Transfer Protocol Secure (HTTPS).

The conference control unit 11 stores a participant in the conference and a device permitted to be connected to the conference in the conference data storage unit 16 in association with identification information of the conference (i.e., a conference identification (ID)). Also, for each conference ID, the conference control unit 11 executes the conference among the communication terminals of the participants in the conference and the devices permitted to be connection to the conference. The conference control unit 11 also records, in the conference data storage unit 16, audio data and moving image data received from the devices connected to the conference as recorded data and, for example, drawing data as whiteboard operation data.

The conference participation device management unit 12 manages information on the communication terminals of the participants who have been authenticated as operators in the conference and information on the devices permitted to be connected to the conference.

The user authentication unit 13 authenticates the operators who participate in the conference by collating the user names and the passwords received via the network communication unit 10 with the user names and the passwords stored in the user data storage unit 14.

The conference reservation unit 15 stores a date and time of the conference, information on the participants in the conference, and the information on the devices permitted to connect to the conference, which are associated with a conference ID, in the conference data storage unit 16 as conference reservation information.

FIG. 3 is a block diagram illustrating a hardware configuration of the laptop PC 2 according to the first embodiment of the present disclosure. As illustrated in FIG. 3, the laptop PC 2 includes a CPU 20, a main memory 21, a read-only memory (ROM) 22, a hard disk (HD) 23, an HD controller 24, a wireless LAN controller 25, an antenna 26, a USB controller 27, a USB terminal 28, a display controller 29, a liquid crystal display (LCD) 30, an ETHERNET controller 31, and an ETHERNET interface (I/F) 32.

The CPU 20 executes processing according to a control processing program stored in the ROM 22, an operating system (OS) read from the HD 23 onto the main memory 21, and various application programs. The main memory 21 is a dynamic random-access memory (DRAM), and is used, for example, as a work area for the CPU 20. The ROM 22 stores in advance programs for starting up the system when the power of the system is turned on and for controlling various devices. The HD controller 24 includes, for example, a micro serial advanced technology attachment (SATA) interface as an interface with the HD 23, and performs high-speed data transfer with the HD 23. The HD 23 stores, for example, system software, various application programs, and data operated to be stored by the operator.

The wireless LAN controller 25 controls communication with other devices by transmitting and receiving radio waves via the antenna 26 according to a communication protocol conforming to the Institute of Electrical and Electronics Engineers (IEEE) 802.11ax standard. The USB controller 27 controls communication with other devices connected by a USB cable via a USB terminal 28 that is a terminal (receptacle) for USB Type C (referred to as USB-C in the following description). The display controller 29 performs control for displaying data such as character data and graphic data on the LCD 30. The ETHERNET controller 31 controls communication with other devices connected to the ETHERNET via the ETHERNET I/F 32 according to a communication protocol conforming to the IEEE 802.3 standard.

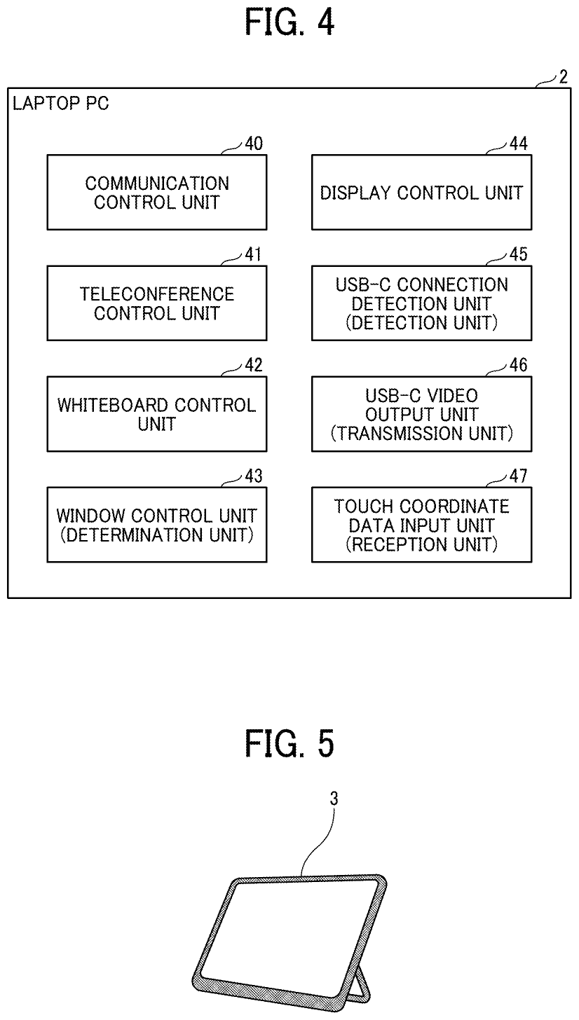

FIG. 4 is a block diagram illustrating a functional configuration of the laptop PC 2 according to the first embodiment of the present disclosure. As illustrated in FIG. 4, the laptop PC 2 includes a communication control unit 40, a teleconference control unit 41, a whiteboard control unit 42, a window control unit 43, a display control unit 44, a USB-C connection detection unit 45, a USB-C video output unit 46, and a touch coordinate data input unit 47. These functional units provide functions implemented by the CPU 20 executing instructions included in one or more programs installed in the laptop PC 2.

The communication control unit 40 controls communication according to a communication protocol such as a transmission control protocol/internet protocol (TCP/IP), a real-time transport protocol control protocol (RTCP), or a hypertext transfer protocol (HTTP), or a wireless communication protocol conforming to the IEEE 802.11ax standard.

The teleconference control unit 41 transmits and receives audio data and video data to and from another laptop PC 2 via the conference server 1, and executes a conference application.

The whiteboard control unit 42 transmits and receives handwritten data and content data (such as documents and photographs) to be displayed on the virtual whiteboard to and from the other laptop PC 2 via the conference server 1.

The window control unit 43 cuts out an area corresponding to the window size from the data stored in the display memory area managed for each application, and overwrites the display data of the desktop with the area. The window control unit 43 also overwrites the display data of the desktop in accordance with the operation of changing the position or size of the window to update the display of the desktop. The window control unit 43 further includes a determination unit that determines whether the application activated on the laptop PC 2 is a specific application (such as the whiteboard application in the present embodiment) that is registered in advance. In the case where the application activated on the laptop PC 2 is determined to be the specific application (i.e., the whiteboard application) registered in advance, the window control unit 43 transmits data of the application to be stored in the display memory to the USB-C video output unit 46 in order to transmit the data to the touch panel display 3.

The display control unit 44 periodically causes the LCD 30 to display the data stored in the display memory area of the desktop.

The USB-C connection detection unit 45 detects that a USB-C cable is connected to the USB terminal 28. The USB-C connection detection unit 45 includes a detection unit that detects the connection with the touch panel display 3.

In the case where the application activated on the laptop PC 2 is determined to be the specific application registered in advance, the USB-C video output unit 46 includes a transmission unit that transmits, in the DISPLAYPORT Alternative (Alt) Mode, the data of the application to be stored in the display memory (that is, screen data) to the touch panel display 3 whose connection is detected by the USB-C connection detection unit 45.

The touch coordinate data input unit 47 includes a reception unit that receives, via the USB-C cable, coordinate data (touch coordinate data) indicating an operation position on a screen displayed by the touch panel display 3 based on the screen data.

The touch panel display 3 is an input and output device having a touch panel (a display with a touch panel). In FIG. 5, an external view of the touch panel display 3 is illustrated.

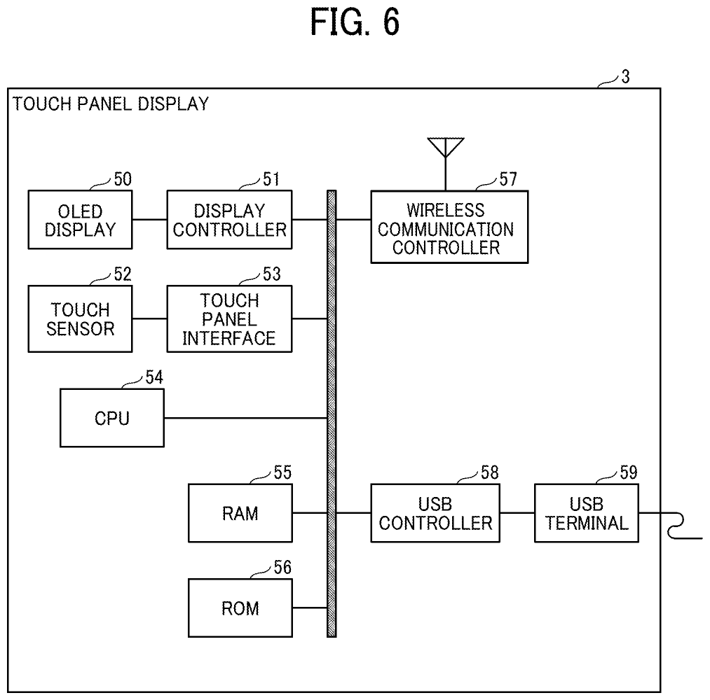

FIG. 6 is a block diagram illustrating a hardware configuration of the touch panel display 3 according to the first embodiment of the present disclosure. As illustrated in FIG. 6, the touch panel display 3 includes an organic light-emitting diode (OLED) display 50, a display controller 51, a touch sensor 52, a touch panel interface 53, a CPU 54, a random-access memory (RAM) 55, a ROM 56, a wireless communication controller 57, a USB controller 58, and a USB terminal 59.

The display controller 51 performs control for displaying, on the OLED display 50, video data input from the USB controller 58.

The touch sensor 52 outputs a coordinate signal of a touched position using a capacitance method. The touch panel interface 53 converts the coordinate signal input by the touch sensor 52 into coordinate data.

The RAM 55 is a DRAM and is used as a work area for the CPU 54. The ROM 56 is a non-volatile memory and stores a control program for causing the CPU 54 to execute processing.

The wireless communication controller 57 controls wireless communication such as WIRELESS FIDELITY.

The USB controller 58 executes USB communication with the laptop PC 2 via the USB-C cable connected to the USB terminal 59.

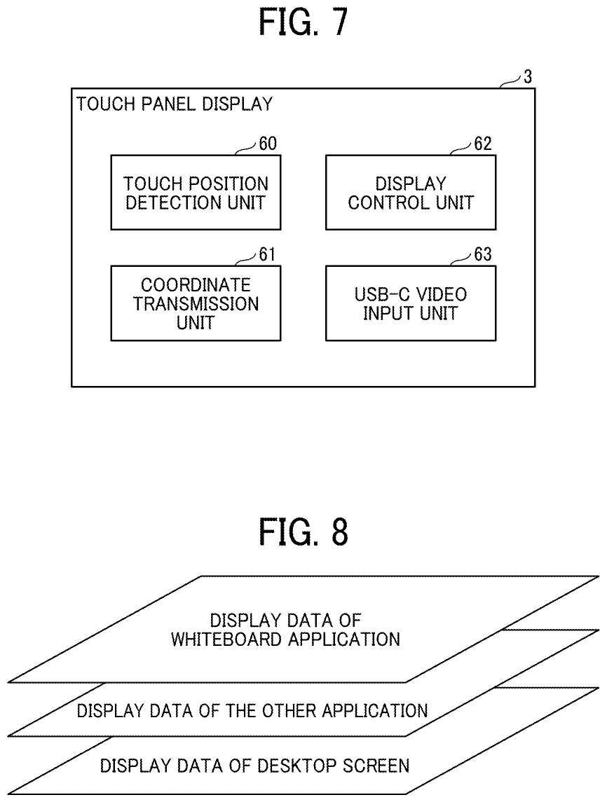

FIG. 7 is a block diagram illustrating a functional configuration of the touch panel display 3 according to the first embodiment of the present disclosure. As illustrated in FIG. 7, the touch panel display 3 includes a touch position detection unit 60, a coordinate transmission unit 61, a display control unit 62, and a USB-C video input unit 63. These functional units provide functions implemented by the CPU 54 executing instructions included in one or more programs installed in the touch panel display 3.

The touch position detection unit 60 detects a touched position (coordinates) on the touch panel based on the coordinate signal input from the touch sensor 52.

The coordinate transmission unit 61 transmits coordinate data indicating the coordinates detected by the touch position detection unit 60 to the laptop PC 2.

The display control unit 62 converts the aspect ratio of the image data received from the USB-C video input unit 63 into the aspect ratio of the OLED display 50 and displays an image based on the image data.

The USB-C video input unit 63 inputs the image data transmitted from the laptop PC 2 in the DISPLAYPORT Alt Mode.

The operation of the laptop PC 2 when the operator instructs the laptop PC 2 to activate an application other than the whiteboard application (referred to as the “other application” in the following description) and the whiteboard application is described below.

When the laptop PC 2 activates the other application in response to an instruction operated by the operator in a state in which the touch panel display 3 is not connected to the laptop PC 2, the LCD 30 displays the screen of the other application. When the laptop PC 2 activates the whiteboard application in response to an instruction operated by the operator, the LCD 30 displays the screen of the whiteboard application.

The CPU 20 of the laptop PC 2 copies the display data of the desktop screen at the time of activating the OS, then copies the display data of the other application, and then copies the display data of the whiteboard application, to the display memory area of the LCD 30. In the display memory area of the LCD 30, as illustrated in FIG. 8, a display layer (i.e., the display data) of the desktop screen, a display layer (i.e., the display data) of the other application, and a display layer (i.e., the display data) of the whiteboard application are virtually overlapped in order from the lower layer.

At this point, when the touch panel display 3 is connected to the laptop PC 2 with the USB-C cable by the operator, the USB-C connection detection unit 45 of the laptop PC 2 detects this connection and receives the device information from the touch panel display 3. When the connection partner is determined to be the touch panel display 3 registered in the laptop PC 2 in advance based on the device information, the USB-C connection detection unit 45 notifies the window control unit 43 that the touch panel display 3 is connected. In response to receiving the notification from the USB-C connection detection unit 45, the window control unit 43 transmits, to the USB-C video output unit 46, the display data of the application that is registered (set) in the laptop PC 2 in advance as a specific application whose screen data is to be output to the outside (transmitting the screen data to the touch panel display 3). In the present embodiment, the whiteboard application corresponds to the application registered as the specific application in advance. Accordingly, the window control unit 43 transmits the display data of the whiteboard application to the USB-C video output unit 46. The USB-C video output unit 46 transmits the display data to the touch panel display 3 in the DISPLAYPORT Alt Mode. After transmitting all the display data of the whiteboard application, the window control unit 43 executes a process to delete the display layer of the whiteboard application from the display memory area of the LCD 30. Specifically, the window control unit 43 copies data stored in a display memory area managed by the other application that is an application in a lower display layer, to the display memory area of the LCD 30 to overwrite the display memory area of the LCD 30 with the data stored in the display memory area managed by the other application. As a result, the display data of the other application is displayed on the LCD 30 of the laptop PC 2, and the display data of the whiteboard application is displayed on the touch panel display 3.

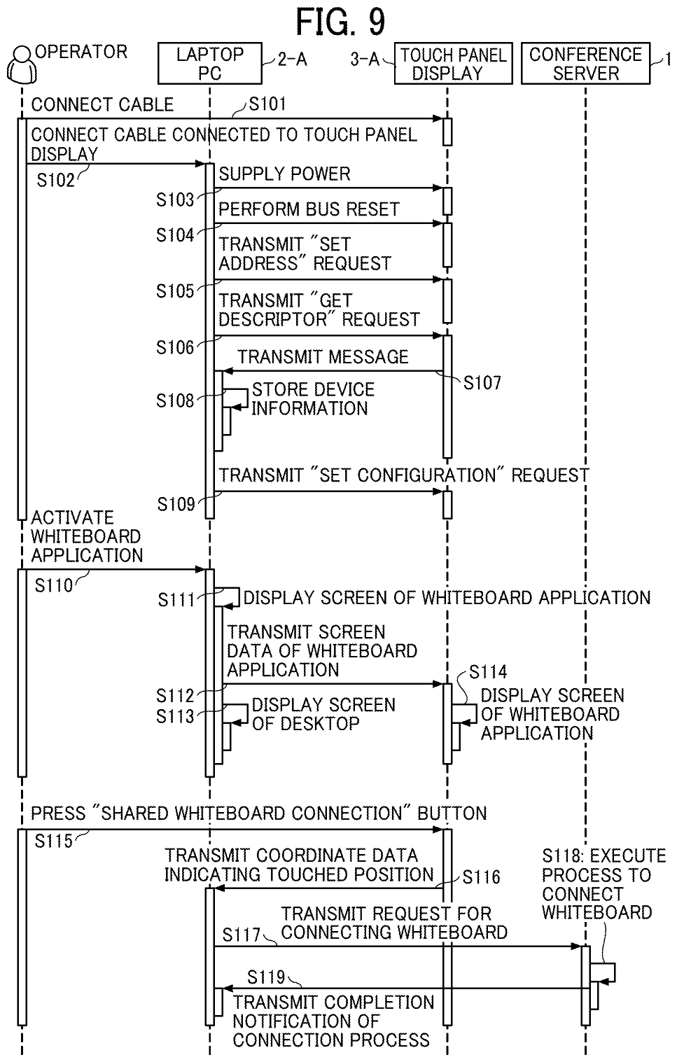

The processing executed in the first embodiment is described below. FIG. 9 is a sequence chart illustrating the processing executed by a system according to the first embodiment of the present disclosure.

The operator is about to participate, using the laptop PC 2-A and the touch panel display 3-A, in a conference in which the whiteboard application is used. The display of the laptop PC 2-A is not equipped with a touch panel. In this conference, using the whiteboard application installed in the laptop PC 2-A, each participant in the conference uses a laptop PC of own to make discussions while drawing on the whiteboard. The whiteboard application is an application for viewing and editing contents displayed on a whiteboard that can be shared with the other laptop PC 2.

In step S101, the operator connects the USB-C cable to the USB terminal 59 of the touch panel display 3-A. Subsequently, the operator connects the connector on the opposite side of the USB-C cable connected to the touch panel display 3-A to the USB terminal 28 of the laptop PC 2-A (S102). When the USB-C connection detection unit 45 of the laptop PC 2-A detects the connection of the USB-C cable, the laptop PC 2-A supplies power to the touch panel display 3-A via the USB-C cable (S103). After the power is supplied, the laptop PC 2-A performs a bus reset on the touch panel display 3-A to set the touch panel display 3-A to a connectable state (S104). Subsequently, the laptop PC 2-A generates an address of the touch panel display 3-A, and transmits a “Set Address” request, in which the address is included, to the touch panel display 3-A (S105). In other words, the address is assigned to the touch panel display 3-A. When the assignment of the address is completed, the laptop PC 2-A transmits a “Get Descriptor” request to the touch panel display 3-A to request information on the device (touch panel display 3-A) (S106). In response to the request, the touch panel display 3-A transmits a message including the device information (a model code of the device) of the touch panel display 3-A to the laptop PC 2-A (S107). When receiving the device information, the laptop PC 2-A stores the device information in the main memory 21 (S108). Subsequently, by the laptop PC 2-A transmitting a “Set Configuration” request to the touch panel display 3-A (S109), the USB device (touch panel display 3-A) becomes usable from the laptop PC 2-A (connectable to the laptop PC 2-A).

When the USB device (touch panel display 3) becomes usable, the laptop PC 2-A activates, in response to an instruction operated by the operator, the whiteboard application already installed (S110). When the whiteboard application is activated, the window control unit 43 of the laptop PC 2-A displays the screen of the whiteboard application on the LCD 30 of the laptop PC 2-A (S111). As a process at the time of activating the whiteboard application, the window control unit 43 of the laptop PC 2-A determines whether a display is already connected to the laptop PC 2-A and whether the display already connected to the laptop PC 2-A is a touch panel display previously stored in the main memory 21 from the model code of the touch panel display 3-A. The model code of the touch panel display 3-A is registered in advance in the HD 23 according to a setting operation. The window control unit 43 further determines whether the whiteboard application is registered in advance as a specific application whose screen data is to be output to the outside. In the case where the model code received from the touch panel display 3-A is determined to be the model code registered in advance and the whiteboard application is determined to be the specific application, the USB-C video output unit 46 of the laptop PC 2-A transmits the screen data of the whiteboard application to the touch panel display 3-A (S112). Subsequently, the window control unit 43 of the laptop PC 2-A deletes the display layer of the whiteboard application to display the desktop screen on the LCD 30 (S113). When the USB-C video input unit 63 of the touch panel display 3-A receives the screen data of the whiteboard application, the display control unit 62 causes the OLED display 50 to display a screen based on the screen data (S114).

When the touch position detecting unit 60 of the touch panel display 3-A detects a touched position in response to touching (pressing) a “shared whiteboard connection” button operated by the operator, which is one of the menu buttons of the whiteboard application displayed on the OLED display 50 (S115), the coordinate transmission unit 61 of the touch panel display 3-A transmits coordinate data indicating the touched position to the laptop PC 2-A (S116). When the touch coordinate data input unit 47 of the laptop PC 2-A receives the coordinate data and the whiteboard control unit 42 determines that the coordinate position in the display data storage area of the whiteboard application is the position of the “shared whiteboard connection” button, the whiteboard application of the laptop PC 2-A transmits, to the conference server 1, a request for connecting the whiteboard (S117). The conference control unit 11 of the conference server 1 executes a process to connect the whiteboard in response to the request (S118). When the process to connect the whiteboard is completed, the conference control unit 11 transmits, to the laptop PC 2-A, a completion notification of the connection of the whiteboard (S119). When the whiteboard application of the laptop PC 2-A receives the completion notification of the connection of the whiteboard from the conference server 1, the laptop PC 2-A and the other laptop PC 2 come into a state in which the whiteboard can be shared. By another operator of the other laptop PC 2 performing the same operation as described above, each of the operators who are participants in the conference can use the same whiteboard.

As described above, according to the first embodiment, simply by connecting the USB cable to the laptop PC 2, the screen of a specific application (such as the whiteboard application) that allows handwriting on a whiteboard can be displayed on the touch panel display 3. As a result, the operation for switching the screen display to the touch panel display 3 is not needed. Accordingly, the operability when the display with a touch panel is connected is increased. In addition, the productivity of the conference is increased by reducing the workload of operation for the operator.

The second embodiment is described below. In the second embodiment, the features different from the first embodiment are described. Accordingly, the features that are not particularly mentioned are substantially the same as those of the first embodiment.

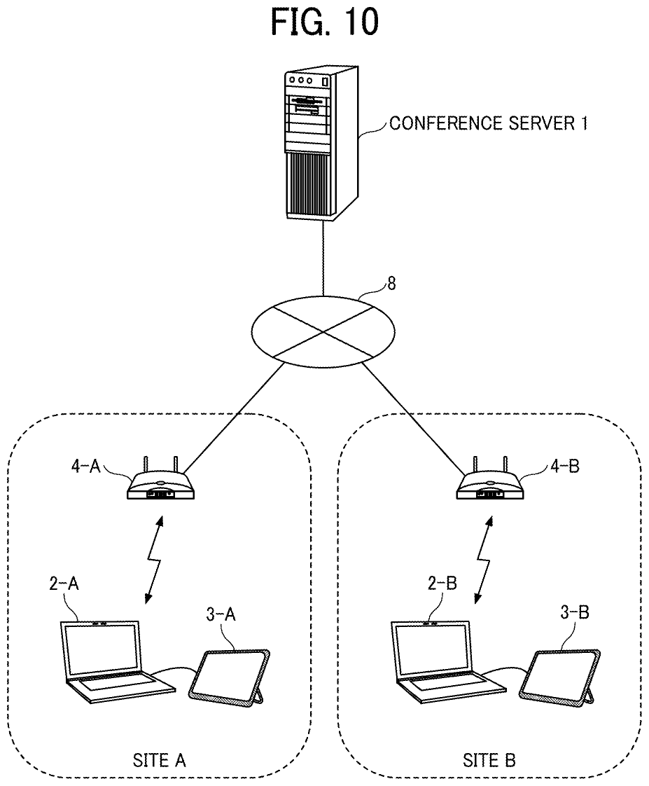

FIG. 10 is a diagram illustrating a configuration of a system according to the second embodiment of the present disclosure. In FIG. 10, like reference signs are allocated to components having the same or similar configuration as those of FIG. 1, and the descriptions thereof are omitted as appropriate.

In FIG. 10, a wireless LAN access point 4-B, the laptop PC 2-B, and the touch panel display 3-B belong to a site B. The wireless LAN access point 4-B is connected to the conference server 1 via the network 8. The laptop PC 2-B is connected to the conference server 1 via the wireless LAN access point 4-B.

The site B is a conference room different from the site A (for example, a conference room in a building different from the building where the site A is). In the second embodiment, the laptop PCs 2 and the touch panel displays 3 are used by participants in a teleconference (referred to simply as a “conference” in the following description) between the site A and the site B.

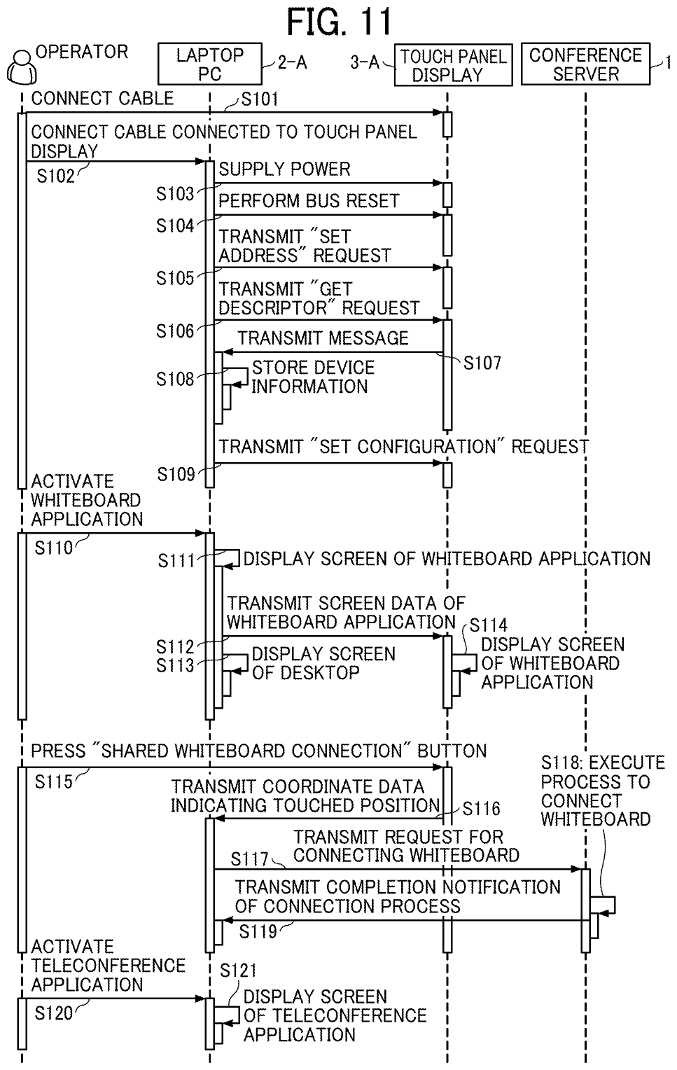

FIG. 11 is a sequence chart illustrating the processing executed by a system according to the second embodiment of the present disclosure. In FIG. 11, the same step numbers are allocated to the same processes as those in the sequence chart of FIG. 9, and the descriptions thereof are omitted as appropriate.

The operator is about to participate, using the laptop PC 2-A and the touch panel display 3-A, in a conference (teleconference) in which the whiteboard application is used. The display of the laptop PC 2-A is not equipped with a touch panel. In this conference, each participant participates in the conference from each site using the whiteboard application and a conference application used for telephone communication, which are already installed in the laptop PC 2 of own. The whiteboard application is an application for viewing and editing contents displayed on a whiteboard that can be shared with the laptop PCs 2 each other.

When the operator connects the USB-C cable to the USB terminal 59 of the touch panel display 3-A and the USB terminal 28 of the laptop PC 2-A, and the whiteboard application installed in the laptop PC 2-A is activated, the same processing as that in the first embodiment is executed, and the screen of the whiteboard application is displayed on the touch panel display 3-A, and the desktop screen is displayed on the laptop PC 2-A (S101 to S119).

In this state, when the laptop PC 2-A activates the conference application in response to an instruction operated by the operator (S120), the window control unit 43 of the laptop PC 2-A determines that the conference application is not the application that is set in the laptop PC 2-A in advance as the application whose screen data is to be output to the outside, and displays the screen of the conference application on the LCD 30 (S121). When the operator selects a “start conference” button of the conference application, the laptop PC 2-A connects to the conference server 1, and comes into a state where the laptop PC 2-A holds the conference in which the drawing on the whiteboard is shared while the operator talking with the other operator of the laptop PC 2-B at the site B.

The third embodiment is described below. In the third embodiment, the features different from the second embodiment are described. Accordingly, the features that are not particularly mentioned are substantially the same as those of the second embodiment.

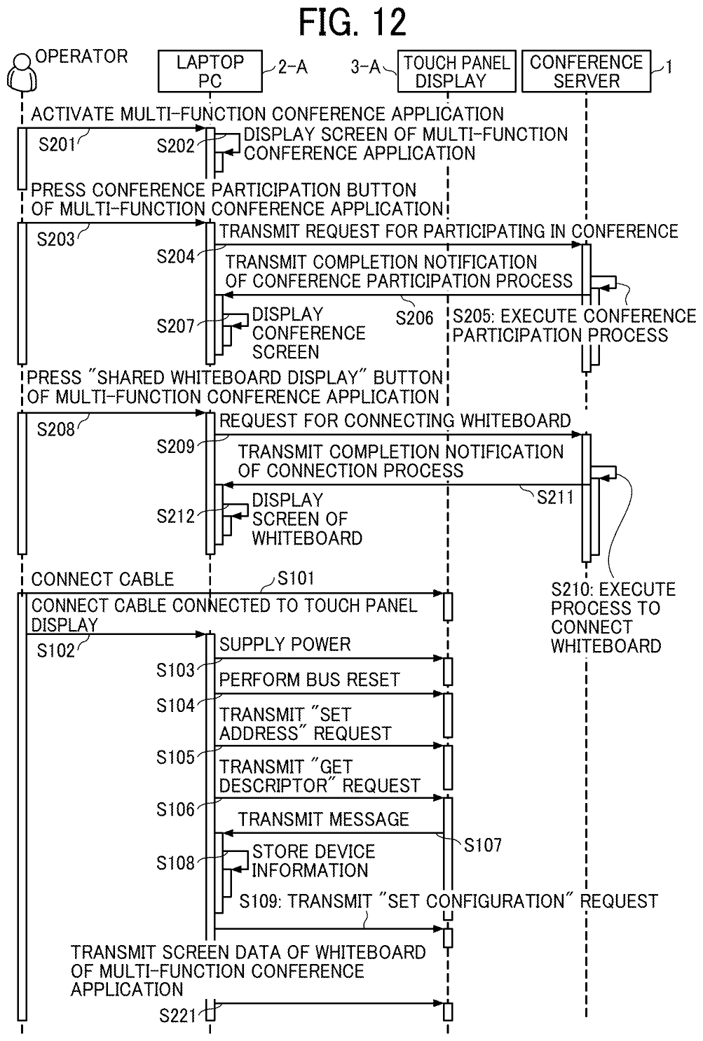

FIG. 12 is a sequence chart illustrating the processing executed by a system according to the third embodiment of the present disclosure. In FIG. 12, the same step numbers are allocated to the same processes as those in the sequence chart of FIG. 11, and the descriptions thereof are omitted as appropriate.

The operator is about to participate, using the laptop PC 2-A and the touch panel display 3-A, in a conference (teleconference) in which the whiteboard application is used. The display of the laptop PC 2-A is not equipped with a touch panel. In this conference, the operator uses a multi-function conference application of a composite type already installed in the laptop PC 2-A, which allows displaying and editing contents on a shared whiteboard and telephone communication. In other words, the multi-function conference application of the composite type is different from the whiteboard application of the first embodiment and the second embodiment in that the multi-function conference application allows the telephone communication.

In response to an instruction operated by the operator, the laptop PC 2-A activates the multi-function conference application already installed (S201). When the multi-function conference application is activated, the window control unit 43 of the laptop PC 2-A displays the screen of the multi-function conference application on the LCD 30 of the laptop PC 2-A (S202).

Subsequently, when the operator presses a conference participation button of the multi-function conference application, the multi-function conference application installed in the laptop PC 2-A starts a process to participate in the conference (S203). First, the multi-function conference application transmits a request for participating in the conference to the conference server 1 (S204). In response to receiving the request for participating in the conference, the conference participation device management unit 12 of the conference server 1 executes a process to participate in the conference (S205). When the process to participate in the conference is completed, the conference participation device management unit 12 transmits a completion notification of the participation in the conference to the multi-function conference application installed in the laptop PC 2-A (S206). In response to receiving the completion notification of the participation in the conference from the conference server 1, the multi-function conference application installed in the laptop PC 2-A displays a conference screen (S207). At this point, the process to participate in the conference is completed and the conference comes into a state where the telephone communication between the remote sites is enabled. By the other operator of the other laptop PC 2 at the other site performing the same operation as described above, the operators can talk with each other.

In response to pressing operated by the operator on a “shared whiteboard display” button of the multi-function conference application (S208), the multi-function conference application installed in the laptop PC 2-A transmits, to the conference server 1, a request for connecting the shared whiteboard (S209). In response to the request, the conference control unit 11 of the conference server 1 executes a process to connect the shared whiteboard (S210). When the process to connect the shared whiteboard is completed, the conference control unit 11 transmits, to the laptop PC 2-A, a completion notification of the connection of the shared whiteboard (S211). In response to receiving the completion notification of the connection of the shared whiteboard from the conference server 1, the multi-function conference application installed in the laptop PC 2-A displays the screen of the whiteboard (shared whiteboard) (S212). As a result, the laptop PC 2-A comes into a state where the laptop PC 2-A can share the whiteboard with the other laptop PC 2 at the other site. By the other operator of the other laptop PC 2 at the other site performing the same operation as described above, the operators at each site can share the same whiteboard.

When the operator connects the USB-C cable to the USB terminal 59 of the touch panel display 3-A and the USB terminal 28 of the laptop PC 2-A in order to handwrite drawing on the whiteboard, the same processing as that in the first embodiment or the second embodiment is executed, and the laptop PC 2-A receives the model code from the touch panel display 3-A (S101 to S109). In the case where the model code is determined to be the same as the model code registered in advance in the laptop PC 2-A as the destination to which the screen of the whiteboard is transmitted and the window control unit 43 determines that the multi-function conference application is registered in advance as the specific application whose screen data is to be output to the outside, the USB-C video output unit 46 transmits the screen data of the whiteboard to the touch panel display 3-A (S221). The window control unit 43 of the laptop PC 2-A deletes the display layer of the whiteboard to display the screen of the multi-function conference application (the screen before the whiteboard is displayed) on the LCD 30. When the USB-C video input unit 63 of the touch panel display 3-A receives the screen data of the whiteboard, the display control unit 62 causes the OLED display 50 to display a screen based on the screen data.

Thus, the teleconference can be executed while the operators handwrite drawings on the whiteboard displayed on the touch panel display 3-A.

The fourth embodiment is described below. In the fourth embodiment, the features different from the above-described embodiments are described. Accordingly, the features that are not particularly mentioned are substantially the same as those of the above-described embodiments.

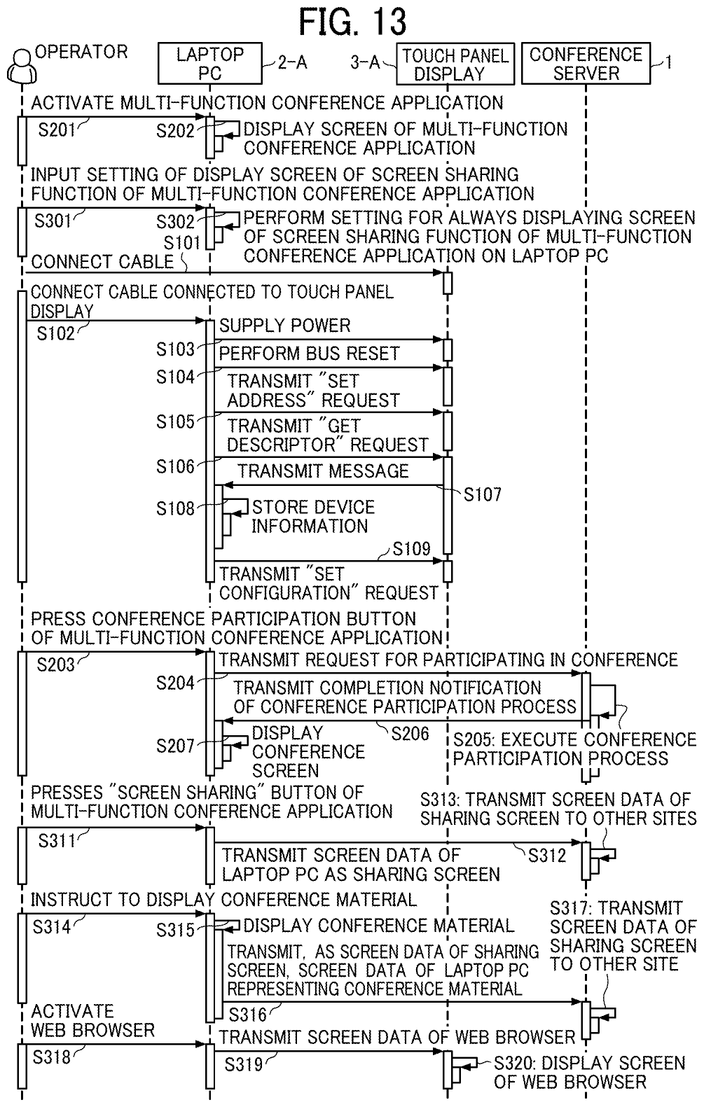

FIG. 13 is a sequence chart illustrating the processing executed by a system according to the fourth embodiment of the present disclosure.

The multi-function conference application of the fourth embodiment has a screen sharing function added to the multi-function conference application described in the third embodiment. The screen sharing function is a function of transmitting the display screen of the laptop PC 2-A to the other laptop PC 2-B and causing the other laptop PC 2-B to display the same display screen of the laptop PC 2-A. Using this function, the same document (conference material) displayed on the laptop PC 2-A can be displayed on all the laptop PCs 2 participating in the teleconference.

When a teleconference is held using the laptop PC 2-A and the touch panel display 3-A, the screen for sharing the conference material is always displayed on the laptop PC 2-A, and the other screens are displayed on the touch panel display 3-A. Applications and functions to be always displayed on the laptop PC 2-A are registered in the laptop PC 2-A in advance. For example, the screen of the screen sharing function of the multi-function conference application is set to be always displayed on the laptop PC 2-A. For this purpose, for example, before the conference starts, the processing of steps S301 and S302 is executed subsequent to the activation of the multi-function conference application (S201, S202).

When the operator performs an input for always displaying the screen of the screen sharing function of the multi-function conference application on the laptop PC 2-A via the setting screen of the multi-function conference application in step S301, the multi-function conference application performs a setting for always displaying the screen of the screen sharing function of the multi-function conference application on the laptop PC 2-A (S302). In other words, the screen sharing function of the multi-function conference application is registered in the laptop PC 2-A as an application or function that is always displayed on the laptop PC 2-A. The information registered in this manner is referred to as “setting information” in the following description.

When the operator connects the USB-C cable to the USB terminal 59 of the touch panel display 3-A and the USB terminal 28 of the laptop PC 2-A, the processing of steps S101 to S109 is executed.

When the operator presses the conference participation button of the multi-function conference application, the multi-function conference application installed in the laptop PC 2-A connects to the conference server 1 and the conference comes into a state where the telephone communication among operators at multi sites is enabled, as in the third embodiment (S203 to S207).

When the operator presses a “screen sharing” button of the multi-function conference application (S311), the teleconference control unit 41 of the laptop PC 2-A transmits the screen data displayed on the laptop PC 2-A to the other laptop PC 2 (for example, the laptop PC 2-B) at the other site via the conference server 1 (S312, S313). The laptop PC 2-B displays the received screen data on the LCD 30. In response to an instruction operated by the operator (S314), when the laptop PC 2-A displays the conference material (S315), the teleconference control unit 41 transmits the screen data of the conference material to the laptop PC 2-B via the conference server 1 (S316, S317). As a result, the conference material is displayed also on the laptop PC 2-B.

At this point, the laptop PC 2-A activates a web browser in response to an instruction operated by the operator who is to obtain information related to the conference material from the Internet (S318). The window control unit 43 of the laptop PC 2-A refers to the setting information and determines that the web browser is not the application whose screen is to be always displayed on the laptop PC 2-A. In other words, in the present embodiment, the web browser corresponds to an application that is registered in the laptop PC 2-A in advance as an application whose screen data is to be output to the outside. Accordingly, the window control unit 43 inputs the display data of the web browser to the USB-C video output unit 46. The USB-C video output unit 46 transmits the display data of the web browser to the touch panel display 3-A (S319). When the USB-C video input unit 63 of the touch panel display 3-A receives the display data of the web browser, the display control unit 62 of the touch panel display 3-A displays the screen of the web browser on the OLED display 50 based on the display data. At this time, the window control unit 43 does not copy the display data of the web browser to the display memory area of the LCD 30.

In this manner, the screens of the other functions of the multi-function conference application and the screens of the other applications are displayed on the touch panel display 3-A until the screen sharing function is turned off.

As described above, according to the fourth embodiment, the conference material is always displayed on the laptop PC 2 and the other screen data is displayed on the touch panel display 3. As a result, when a search is performed using the web browser, the operation of switching the screen display of the web browser to the touch panel display 3 is not needed, and the productivity of the teleconference is increased.

The fifth embodiment is described below. In the fifth embodiment, the features different from the above-described embodiments are described. Accordingly the features that are not particularly mentioned are substantially the same as those of the above-described embodiments.

In the above-described embodiments, the laptop PC 2-A and the touch panel display 3-A are connected by the USB-C cable. In the fifth embodiment, a case in which the laptop PC 2-A and the touch panel display 3-A are connected by a wireless LAN is described.

FIG. 14 is a block diagram illustrating a functional configuration of the laptop PC 2 according to the fifth embodiment of the present disclosure. In FIG. 14, like reference signs are allocated to components having the same or similar configuration as those of FIG. 4, and the descriptions thereof are omitted as appropriate.

As illustrated in FIG. 14, the laptop PC 2 does not include the USB-C connection detection unit 45. On the other hand, the laptop PC 2 includes a wireless video output unit 48 instead of the USB-C video output unit 46. The wireless video output unit 48 is implemented by the CPU 20 executing instructions included in one or more programs installed in the laptop PC 2.

The wireless video output unit 48 transmits video data to a display device (e.g., the touch panel display 3) in accordance with the specifications of MIRACAST.

The communication control unit 40 can use an infrastructure mode and an ad hoc mode (for example, WIRELESS FIDELITY Direct) as the wireless LAN.

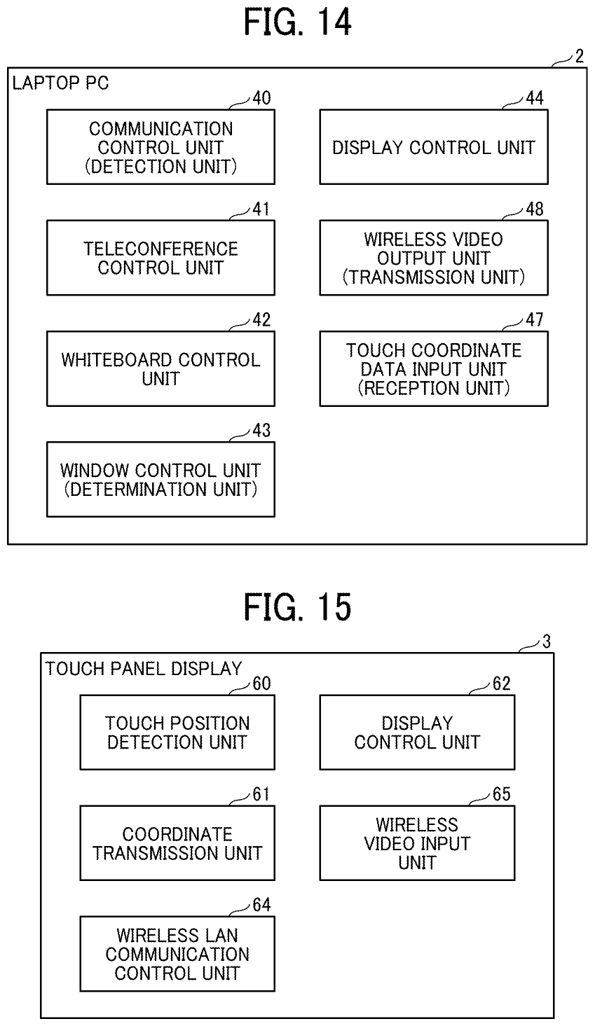

FIG. 15 is a block diagram illustrating a functional configuration of the touch panel display 3 according to the fifth embodiment of the present disclosure. In FIG. 15, like reference signs are allocated to components having the same or similar configuration as those of FIG. 7, and the descriptions thereof are omitted as appropriate.

As illustrated in FIG. 15, the touch panel display 3 further includes a wireless LAN communication control unit 64. The touch panel display 3 also includes a wireless video input unit 65 instead of the USB-C video input unit 63. The wireless LAN communication control unit 64 and the wireless video input unit 65 are implemented by the CPU 54 executing instructions included in one or more programs installed in the touch panel display 3.

The wireless LAN communication control unit 64 controls communication using WIRELESS FIDELITY Direct.

The wireless video input unit 65 receives the video data from the laptop PC 2 in accordance with the specifications of MIRACAST.

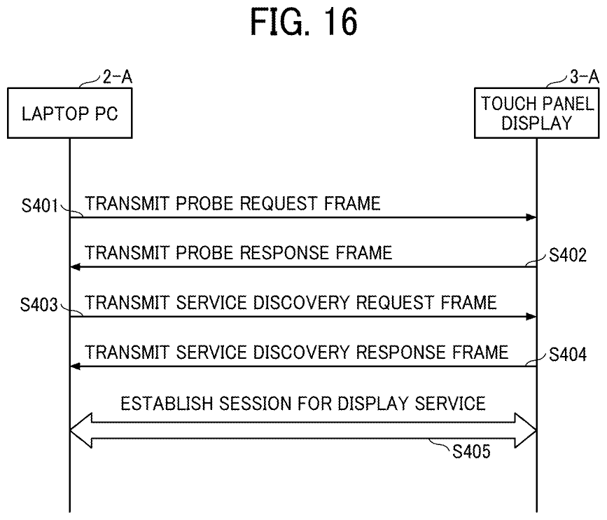

FIG. 16 is a sequence chart illustrating a procedure in which the laptop PC 2 connects to the touch panel display 3 by wireless communication, according to the fifth embodiment of the present disclosure. In FIG. 16, a procedure in which the laptop PC 2-A connects to the touch panel display 3-A using WIRELESS FIDELITY Direct is described.

The communication control unit 40 of the laptop PC 2-A periodically transmits a probe request frame and checks whether a response (probe response frame) is received (S401). In response to receiving the probe request frame, the wireless LAN communication control unit 64 of the touch panel display 3-A transmits a probe response frame (S402).

In response to receiving the probe response frame, the communication control unit 40 of the laptop PC 2-A transmits a service discovery request frame including the service name of the display service (S403). In response to receiving the service discovery request frame, the wireless LAN communication control unit 64 of the touch panel display 3-A transmits a service discovery response frame including the service name of the display service and information indicating that the touch panel is mounted (the information is to be stored in a service information field) (S404).

The communication control unit 40 of the laptop PC 2-A and the wireless LAN communication control unit 64 of the touch panel display 3-A establish a connection to establish a session for the display service (MIRACAST) (S405).

When the session for the display service is established (that is, when the connection with the touch panel display 3-A is detected), the communication control unit 40 of the laptop 2-A notifies the window control unit 43 of the connection of the touch panel display 3-A.

When the laptop PC 2-A activates the whiteboard application in response to an instruction operated by the operator, the window control unit 43 transmits the display data of the whiteboard application to the wireless video output unit 48. The wireless video output unit 48 transmits the display data of the whiteboard application to the touch panel display 3-A using the session for the display service. When the wireless video input unit 65 of the touch panel display 3-A receives the display data of the whiteboard application, the display control unit 62 displays the screen of the whiteboard application on the OLED display 50 based on the display data. At this time, the window control unit 43 does not copy, to the display memory area of the LCD 30, the display data (display data of the whiteboard application) stored in the memory area storing the whiteboard application.

The laptop PC 2-A may display a button for turning on or off the function of WIRELESS FIDELITY Direct. When the operator selects the button for turning on the function of WIRELESS FIDELITY Direct, the operation described above is performed.

Establishing the session for the display service (MIRACAST) corresponds to the allocation of data input and output. In the laptop PC 2-A, the communication control unit 40 allocates data input and output with the touch panel display 3-A. In the touch panel display 3, the wireless LAN communication control unit 64 allocates data input and output with the laptop PC 2.

As described above, according to the fifth embodiment, the same effects as those of the first embodiment can be obtained by using the wireless communication.

Each function of the embodiments of the present disclosure described above may be implemented by one processing circuit or a plurality of processing circuits. The “processing circuit or circuitry” herein includes a programmed processor to execute functions by software, such as a processor implemented by an electronic circuit, and devices, such as an application specific integrated circuit (ASIC), a digital signal processor (DSP), a field programmable gate array (FPGA), and circuit modules known in the art arranged to perform the recited functions.

In the above embodiments, the laptop PC 2 serves as an information processing apparatus. The USB-C connection detection unit 45 in the above embodiments and the communication control unit 40 in the fifth embodiment serve as detection units. The window control unit 43 serves as a determination unit. The USB-C video output unit 46 and the wireless video output unit 48 serve as transmission units. The touch coordinate data input unit 47 serves as a reception unit. The whiteboard application serves as the first application.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Aspects of the present disclosure are, for example, as follows.

### Aspect 1

A display system includes a display with a touch panel and an information processing apparatus. The information processing apparatus includes a detection unit that detects connection with the display with a touch panel, a determination unit that determines whether the first application activated on the information processing apparatus is a specific application registered in advance, a transmission unit that transmits, based on a determination that the first application is the specific application, screen data of the first application to the display with a touch panel whose connection is detected, and a reception unit that receives coordinate data indicating an operation position on a screen displayed by the display with a touch panel based on the screen data. In the display system, the first application causes the information processing apparatus to execute a process according to the coordinate data.

### Aspect 2

In the display system according to Aspect 1, the specific application is registered as an application whose screen data is to be transmitted to the display with a touch panel.

### Aspect 3

In the display system according to Aspect 1 or 2, the detection unit detects connection with the display with a touch panel via a universal serial bus (USB) cable.

### Aspect 4

In the display system according to Aspect 1 or 2, the detection unit detects connection with the display with a touch panel by wireless communication.

### Aspect 5

In a display method, an information processing apparatus includes a detection procedure of detecting connection with a display with a touch panel, a determination procedure of determining whether the first application activated on the information processing apparatus is a specific application registered in advance, a transmission procedure of transmitting, based on a determination that the first application is the specific application, screen data of the first application to the display with a touch panel whose connection is detected, and a reception procedure of receiving coordinate data indicating an operation position on a screen displayed by the display with a touch panel based on the screen data. In the display method, the first application causes the information processing apparatus to execute a process according to the coordinate data.

### Aspect 6

A program product causes an information processing apparatus to include a detection procedure of detecting connection with a display with a touch panel, a determination procedure of determining whether the first application activated on the information processing apparatus is a specific application registered in advance, a transmission procedure of transmitting, based on a determination that the first application is the specific application, screen data of the first application to the display with a touch panel whose connection is detected, and a reception procedure of receiving coordinate data indicating an operation position on a screen displayed by the display with a touch panel based on the screen data. The program product causes the first application to cause the information processing apparatus to execute a process according to the coordinate data.

Any one of the above-described operations may be performed in various other ways, for example, in an order different from the one described above.

Processors are considered processing circuitry or circuitry as they include transistors and other circuitry therein. In the disclosure, the circuitry, units, or means are hardware that carries out or is programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. A display system comprising:
a display with a touch panel; and
an information processing apparatus including circuitry configured to:
detect connection with the display;
determine whether an application executed by the circuitry of the information processing apparatus is a specific application registered in advance;
transmit, based on a determination that the application is the specific application, screen data of the specific application to the display whose connection is detected; and
receive coordinate data indicating an operation position on a screen displayed by the display based on the screen data,
wherein the specific application executes a process according to the coordinate data.

2. The display system according to claim 1, wherein the specific application is registered as an application whose screen data is to be transmitted to the display.

3. The display system according to claim 1, wherein the circuitry is configured to detect connection with the display via a universal serial bus (USB) cable.

4. The display system according to claim 1, wherein the circuitry is configured to detect connection with the display by wireless communication.

5. A display method comprising:
detecting connection with a display with a touch panel;
determining whether an application executed by an information processing apparatus is a specific application registered in advance;
transmitting, based on a determination that the application is the specific application, screen data of the specific application to the display whose connection is detected;
receiving coordinate data indicating an operation position on a screen displayed by the display based on the screen data; and
with the specific application, executing a process according to the coordinate data.

6. A non-transitory recording medium storing a plurality of program codes which, when executed by one or more processors, causes the one or more processors to perform a method, the method comprising:
detecting connection with a display with a touch panel;
determining whether an application executed by an information processing apparatus is a specific application registered in advance;
transmitting, based on a determination that the application is the specific application, screen data of the specific application to the display whose connection is detected;
receiving coordinate data indicating an operation position on a screen displayed by the display based on the screen data; and
with the specific application, executing a process according to the coordinate data.
